(19) United States
(12) Patent Application Publication
(10) Pub. No.: US 2013/0076098 A1
(43) Pub. Date: Mar. 28, 2013

(54) CONVERTIBLE SEAT FOR VEHICLE

(71) Applicant: Alan Neterer, Elkhart, IN (US)

(72) Inventor: Alan Neterer, Elkhart, IN (US)

(73) Assignee: NORCO INDUSTRIES, INC., Compton, CA (US)

(21) Appl. No.: 13/241,157

(22) Filed: Sep. 22, 2011

(51) Int. Cl. B60N 2/68; B23P 11/00

(52) U.S. Cl. 297/452.18; 29/428

(57) ABSTRACT

A convertible seat frame for a vehicle includes a frame component having at least a first end channel. The end channel has a base portion with at least one flange extending away from the base portion. A cross member is fixably attached to the end channel. The frame component may have a second end channel and the cross member may is fixably attached to the second end channel and extends between the first end channel and the second end channel. The frame component may be a seat back frame component or a seat bottom frame component. The cross members may be attached to the end channels by welding. Further, the convertible seat frame may include a second frame component having at least one support leg, and a hinge connected to the second frame component. The first frame component may be connected to the hinge.

### BACKGROUND

This invention relates in general to convertible sofas or seat beds, particularly convertible sofas for vehicles.

One type of convertible sofa includes a seat bottom and a seat back hinged relative to one another. In such an arrangement, the seat back may be in an upright position, thus forming a sofa or bench seat with the seat bottom. Alternatively, the seat back may be in a horizontal position, generally aligned with the seat bottom, thus forming a bed with the seat bottom. One hinge mechanism for such an arrangement is a jack knife hinge.

Convertible seat beds are often used in vehicles, where space is generally a premium, when it is desired to have sleeping accommodations. Most commonly, such seat beds are found in recreational vehicles. However, such seat beds may also be used in any other suitable vehicle, such as the cab of a semi-tractor, extended cab pickup trucks, vans, minivans, or the like.

### SUMMARY

This invention relates to a frame component for a convertible seat for a vehicle.

A convertible seat frame for a vehicle includes a frame component having at least a first end channel. The end channel has a base portion with at least one flange extending away from the base portion. A cross member is fixably attached to the end channel. The frame component may have a second end channel and the cross member may is fixably attached to the second end channel and extends between the first end channel and the second end channel. The frame component may be a seat back frame component or a seat bottom frame component. The cross members may be attached to the end channels by welding. Further, the convertible seat frame may include a second frame component having at least one support leg, and a hinge connected to the second frame component. The first frame component may be connected to the hinge.

Various aspects will become apparent to those skilled in the art from the following detailed description and the accompanying drawings.

### BRIEF DESCRIPTION OF THE DRAWINGS

FIG. 1 is a side perspective view of a convertible seat frame for a vehicle according to one embodiment,

FIG. 2 is a front perspective view of the convertible seat frame of FIG. 1,

FIG. 3A is a perspective view of the seat back frame component of the convertible seat frame of FIGS. 1 and 2,

FIG. 3B is a top view of the seat back frame component of FIG. 3A,

FIG. 3C is a side view of the seat back frame component of FIG. 3A,

FIG. 3D is a front view of the seat back frame component of FIG. 3A,

FIG. 4A is a perspective view of the seat bottom frame component of the convertible seat frame of FIGS. 1 and 2,

FIG. 4B is a top view of the seat bottom frame component of FIG. 4A,

FIG. 4C is a side view of the seat bottom frame component of FIG. 4A,

FIG. 4D is a front view of the seat bottom frame component of FIG. 4A,

FIG. 4E is an enlarged portion of FIG. 4B,

FIG. 4F is an enlarged portion of FIG. 4C,

FIG. 5 is an enlarged top perspective view of an end portion of the seat bottom frame component of FIG. 4A,

FIG. 6 is an enlarged bottom perspective view of the end portion of FIG. 5,

FIG. 7A is a perspective view of the end channel of the seat back frame component of FIGS. 3A-3D,

FIG. 7B is a top view of the end channel of FIG. 7A,

FIG. 7C is a side view of the end channel of FIG. 7A,

FIG. 7D is an end view of the end channel of FIG. 7A,

FIG. 7E is a plan view of a stamped sheet to form the end channel of FIG. 7A,

FIG. 8A is a perspective view of the end channel of the portion of a seat frame component of FIG. 5,

FIG. 8B is a top view of the end channel of FIG. 8A,

FIG. 8C is a side view of the end channel of FIG. 8A,

FIG. 8D is an end view of the end channel of FIG. 8A, and

FIG. 8E is a plan view of a stamped sheet to form the end channel of FIG. 8A.

### DETAILED DESCRIPTION

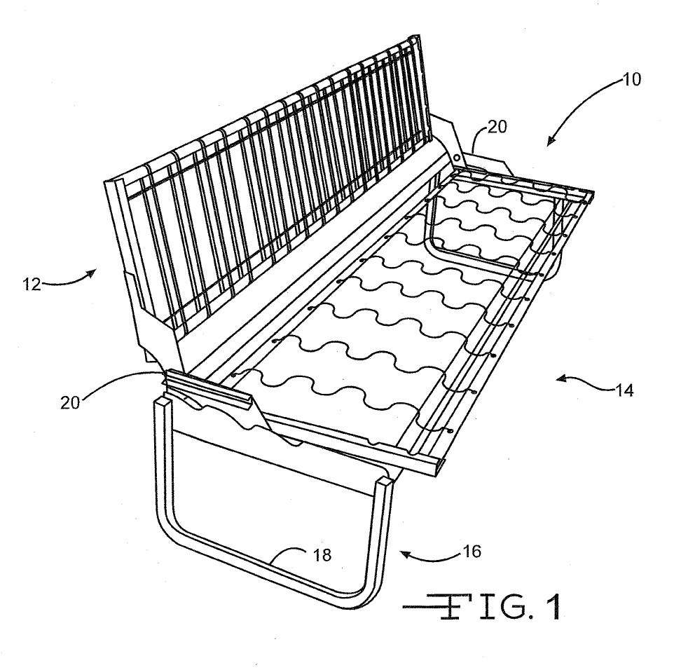

Referring now to the drawings, there is illustrated in FIGS. 1 and 2 a convertible seat frame 10 for a vehicle. The convertible seat frame 10 includes several seat frame components, including a seat back frame component 12, a seat bottom frame component 14, and a seat base component 16.

The seat base frame component 16 is formed for attachment to a vehicle, such as a recreational vehicle, the cab of a semi-tractor, extended cab pickup trucks, vans, minivans, or the like. As illustrated, the seat base frame component 16 includes a tubular leg portion 18, e.g. leg support. which may be fixed to a portion of the vehicle, such as by threaded fasteners, like bolts or screws, or by welding or by any other suitable method of fixing.

The seat back frame component 12 and the seat bottom frame component 14 are moveably attached to the seat base frame component 16 and are preferably hinged relative to one another such that the seat back frame component 12 may be in an upright position, and thus form a sofa or bench seat with the seat bottom frame component 14, or alternatively, the seat back frame component 12 may be in a horizontal position, generally aligned with the seat bottom frame component 14, and thus form a bed with the seat bottom frame component 14. As illustrated, the seat back frame component 12 and the seat bottom frame component 14 are hinged relative to one another by a jack knife hinge 20, although any suitable hinge mechanism may be utilized.

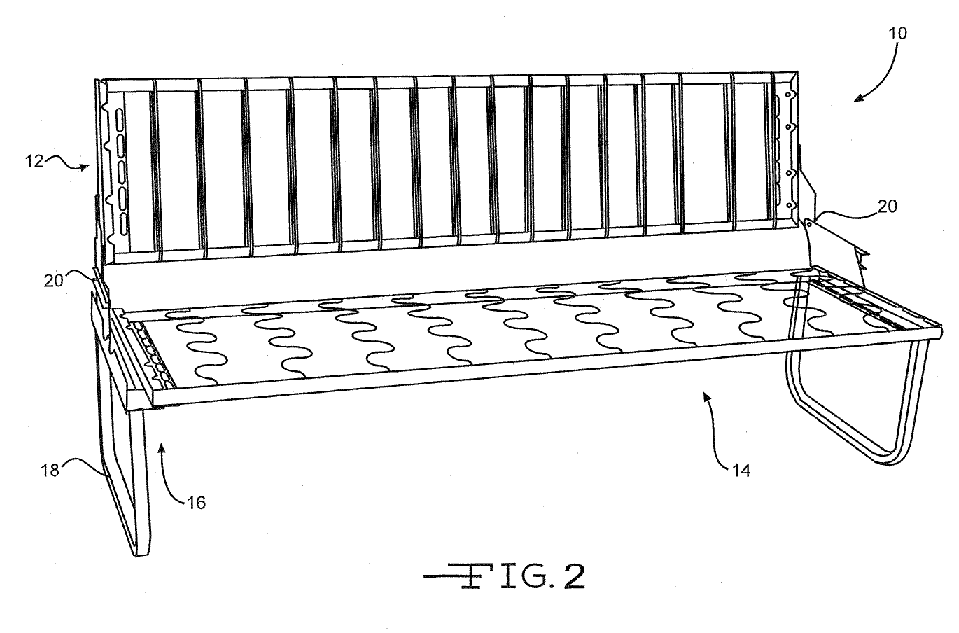

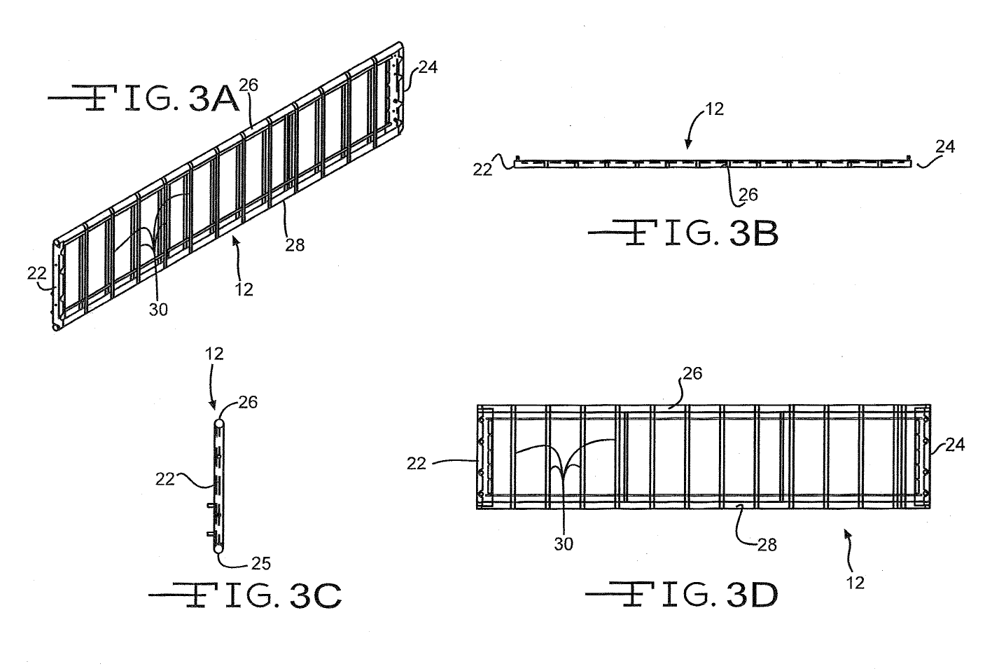

As best shown in FIGS. 3A-3D, the seat back frame component 12 includes first and second channels 22 and 24 and first and second cross members 26 and 28 fixably attached to the end channels 22 and 24. In the illustrated example, the first and second cross members 26 and 28 are attached at opposite ends of the first and second end channels 22 and 24 with first and second cross members 26 and 28 extending in generally parallel orientation, although such is not required.

A plurality of spring members 30 extend between the first and second cross members 26 and 28. As illustrated, the spring members 30 are strap springs, such as those made from metal or plastic ribbon and the like.

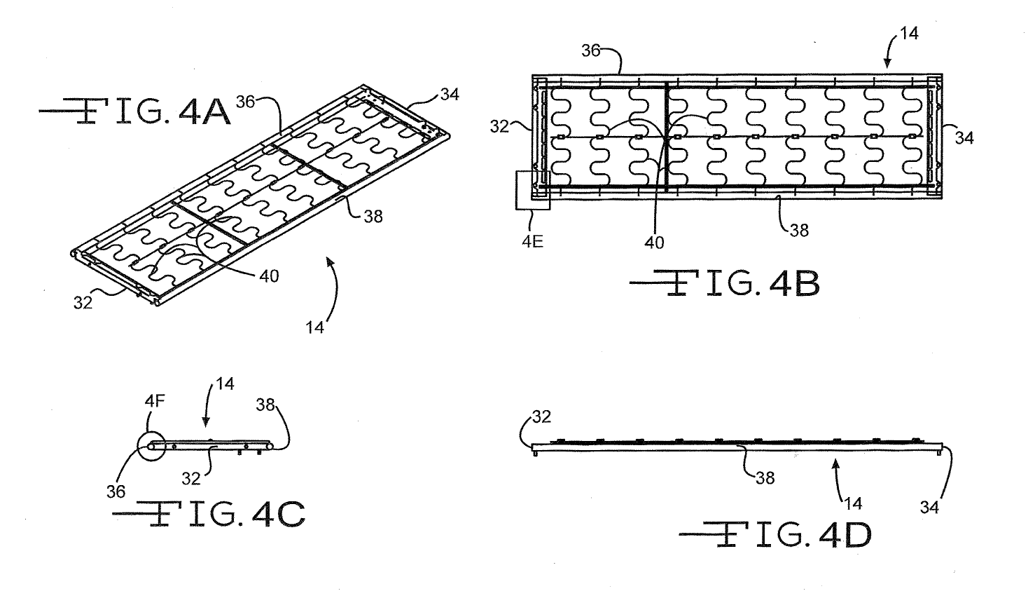

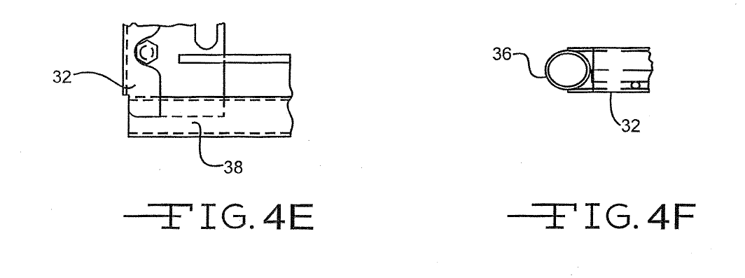

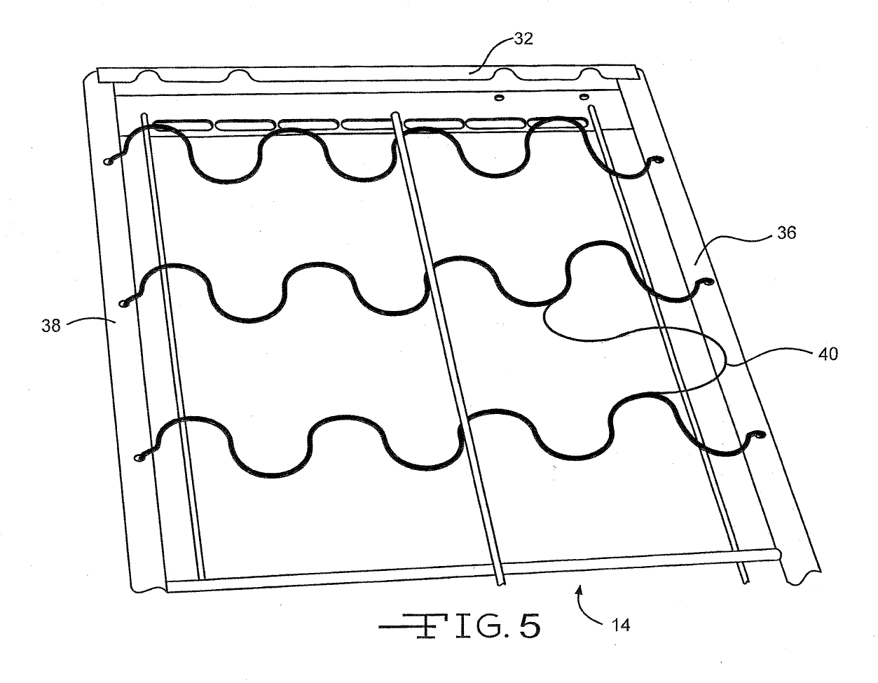

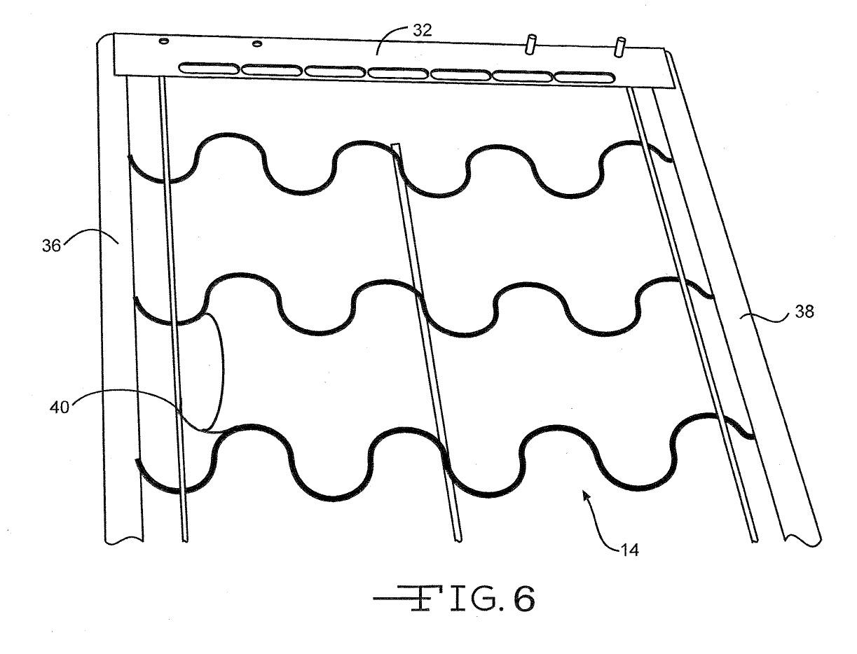

As best shown in FIGS. 4A-4F, and FIGS. 5 and 6, similar to the seat back frame component 12, the seat bottom frame component 14 includes first and second channels 32 and 34 and first and second cross members 36 and 38 fixably attached to the end channels 32 and 34. A plurality of spring members 40 extend between the first and second cross members 36 and 38. As illustrated, the spring members 40 are wire springs, such as those made from metal or plastic wire and the like.

As best shown in Figs, 7A-7D, the end channel 32 has a base portion 42 with a top flange 44 extending away from the base portion 42 in a generally perpendicular direction, although such is not required. A bottom flange 46 extends away from the base portion 42 in a generally perpendicular direction, although such is not required, and thus, in this example, is generally parallel to the top flange 44.

The end channel 32 includes an number of optional apertures 48, 50, 52, 54, 56, 58, 60, and 62, which may be used, for example, for holding to facilitate the machining or assembly process, or for the fastening of the end channel 32 to other components, such as by threaded fasteners, such as screws or bolts, or by rivets and the like.

The end channel 32 also include a number of optional recess 64, 66, 68 and 70, that correspond to associated apertures, in this example apertures 48, 52, 54 and 58. The recesses may provide clearance to allow for improved access to the apertures by tools during the assembly process. Further, in the illustrated example, fasteners extending thought the apertures 48, 52, 54 and 58 are used to attached the end channel 32 to the hinge 20.

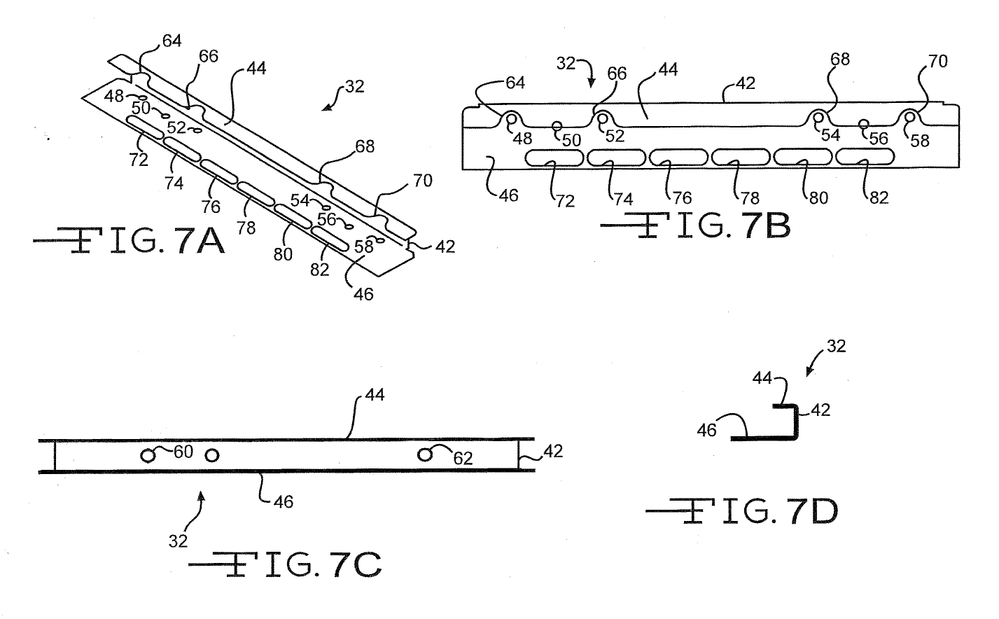

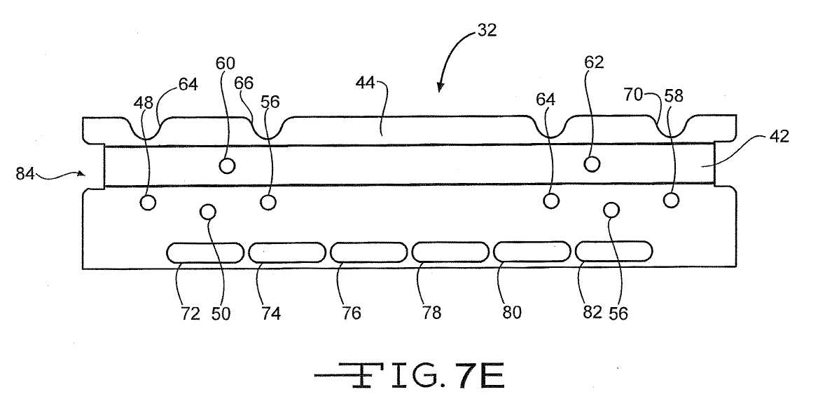

The end channel 32 may be formed from a piece of sheet metal, for example by stamping and/or crimping or bending. Thus the end channel 32 may in at least in one instance be formed from a single stamped sheet 84, as illustrated in FIG. 7E.

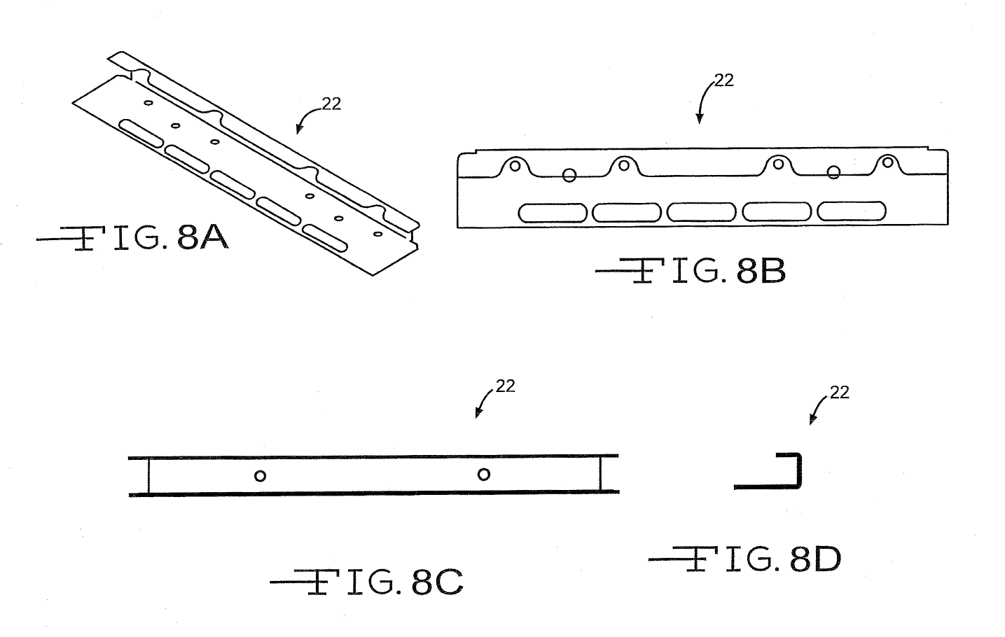

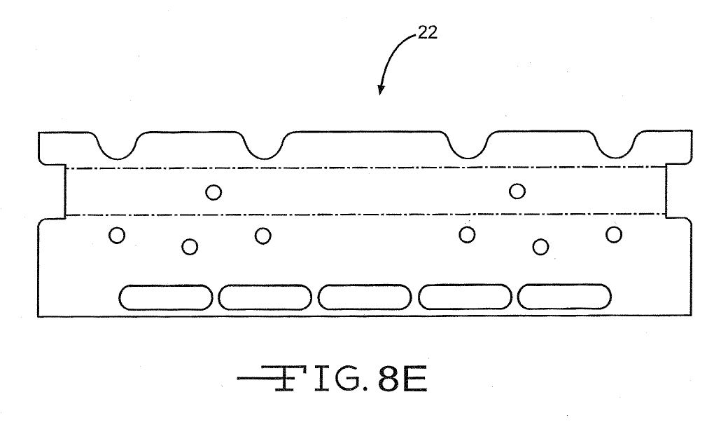

For further example, the end channel 22 is illustrated in FIGS. 8A-8E in a manner similar to the end channel 32 as illustrated in FIGS. 7A-7E. In order to form either of the end channels 22 or 32, or a convertible seat for a vehicle including such a channel, the following method may be utilized. Although, other methods of fabrication are contemplated.

A method for making a convertible seat for a vehicle includes providing a piece of sheet metal. The piece of sheet metal may then be formed into an end channel by stamping, cutting and or bending, as necessary. A cross member may then be provided and attached to the end channel to form a frame component for a convertible seat frame for a convertible seat for a vehicle. The cross member may be fixably attached to the end channel by a weld, or any other suitable attachment arrangement to join the parts for use in a convertible seat.

Further, a second piece of sheet metal may be provided, and formed into a second end channel. The second end channel may then be attached to the cross member to form the frame component for a convertible seat frame for a convertible seat for a vehicle.

Also, a second cross member may be provided and attached to the end channel(s) to form the frame component for a convertible seat frame for a convertible seat for a vehicle. Additionally, at least one spring member may be provided to extend between the first cross member and the second cross member.

The frame component may then be connected to other frame components, such as by a hinge or by appropriate fasteners and the like.

It must be understood that a convertible seat frame may include one or more frame components including and end channel, such as a seat back frame component or a bottom seat frame component. Further, it must be understood that such frame components may be virtually identical in design and dimensions, substantially similar in design and dimensions, or independent and different in design and dimensions.

While principles and modes of operation have been explained and illustrated with regard to particular embodiments, it must be understood, however, that this may be practiced otherwise than as specifically explained and illustrated without departing from its spirit or scope.

What is claimed is:

1. A convertible seat frame for a vehicle comprising:
a frame component including:
an end channel having a base portion with a flange extending away from the base portion, and
a cross member fixably attached to the end channel.

2. The convertible seat frame of claim 1 where the frame component is a seat back frame component.

3. The convertible seat frame of claim 1 where the frame component is a seat bottom frame component.

4. The convertible seat frame of claim 1 where the cross member is fixably attached to the end channel by a weld.

5. The convertible seat frame of claim 1 where the end channel is a first end channel and where the frame component further includes:
a second end channel having a second base portion with a second flange extending away from the second base portion,
where the cross member is fixably attached to the second end channel and extends between the first end channel and the second end channel.

6. The convertible seat frame of claim 1 further comprising:
a second frame component including at least one support leg, and
a hinge connected to the second frame component,
where the first frame component is connected to the hinge.

7. A frame component for a convertible seat for a vehicle comprising:
an end channel including a base portion with a flange extending away from the base portion, and
a cross member fixably attached to the end channel.

8. The frame component of claim 7 where the cross member and the end channel form a seat back frame component.

9. The frame component of claim 7 where the cross member and the end channel form a seat bottom frame component.

10. The frame component of claim 7 where the cross member is fixably attached to the end channel by a weld.

11. The frame component of claim 7 where the end channel is a first end channel and where the frame component further comprises:
a second end channel having a second base portion with a second flange extending away from the second base portion,
where the cross member is fixably attached to the second end channel and extends between the first end channel and the second end channel.

12. The frame component of claim 11 where the cross member is a first cross member and where the frame component further comprises:
a second cross member fixably attached to the first end channel and the second end channel and extends between the first end channel and the second end channel.

13. The frame component of claim 12 where at least one spring member extends between the first cross member and the second cross member.

14. The frame component of claim 13 where the spring member is a wire spring.

15. The frame component of claim 13 where the spring member is a strap member.

16. The frame component of claim 12 where a plurality of spring members extend between the first cross member and the second cross member.

17. A method of making a convertible seat for a vehicle comprising:
a. providing a piece of sheet metal,
b. forming an end channel from the piece of sheet metal,
c. proving a cross member, and
d. attaching the cross member to the end channel to form a frame component for a convertible seat frame for a convertible seat for a vehicle.

18. The method of claim 17 where piece of sheet metal is a first piece of sheet metal and where the end channel is a first end channel and where the method further comprises:
e. providing a second piece of sheet metal,
f. forming a second end channel from the second piece of sheet metal, and
g. attaching the cross member to the second end channel to form a frame component for a convertible seat frame for a convertible seat for a vehicle.

19. The method of claim 17 where the cross member is a first cross member and where method further comprises:
e. attaching the second cross member to the end channel to form a frame component for a convertible seat frame for a convertible seat for a vehicle.

20. The method of claim 19 further comprising:
f. providing at least one spring member, and
g. extending the spring member between the first cross member and the second cross member.
